(19) United States
(12) Patent Application Publication
(10) Pub. No.: US 2006/0041053 A1
(43) Pub. Date: Feb. 23, 2006

(54) Color filter black matrix resist composition and carbon black dispersion composition used for the composition

(76) Inventors: Hirotoshi Kamata, Kanagawa (JP); Masanao Kamijo, Kanagawa (JP); Mina Onishi, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 10/539,283

(22) PCT Filed: Dec. 17, 2003
(86) PCT No.: PCT/JP03/16174

§ 371 Date: Jun. 16, 2005

Related U.S. Application Data
(60) Provisional application No. 60/435,997, filed on Dec. 26, 2002.

(30) Foreign Application Priority Data
Dec. 18, 2002 (JP) 2002-366878

(51) Int. Cl. C08L 31/00

(52) U.S. Cl. 524/556

(57) ABSTRACT

The present invention provides a carbon black dispersion composition for a color filter black matrix resist composition, containing (A) a carbon black having specified physical properties (average primary particle diameter, concentration of surface carboxyl groups), (B) a copolymer having an amino group and/or its quaternary ammonium salt, and (C) an organic solvent, and a color filter black matrix resist composition that contains the above-mentioned dispersion composition, (D) a binder resin having a carboxyl group, (E) an ethylenically unsaturated monomer, (F) a photopolymerization initiator, and (G) specified multifunctional thiol compound and can easily form a thin film or pattern having high light-shielding property by photolithographic method pattern, has excellent storage stability, and exhibits sufficient sensitivity and resolution.

### CROSS-REFERENCE TO THE RELATED APPLICATIONS

This is an application filed pursuant to 35 U.S.C. Section 111(a) with claiming the benefit of U.S. Provisional application Ser. No. 60/435,997 filed on Dec. 26, 2002, under the provision of 35 U.S.C. Section 111(b), pursuant to 35 U.S.C. Section 119(e) (1).

### TECHNICAL FIELD

The present invention relates to color filter black matrix resist used for the production of an optical color filter that is employed in color television sets, liquid crystal display devices, solid image pickup devices, cameras and so forth and to a carbon black dispersion used therefor. More particularly, the present invention relates to a carbon black dispersion for color filter black matrix resists containing carbon black in high concentrations yet having excellent dispersion stability, to a production method thereof, and to a color filter black matrix resist composition being highly light-shielding yet having excellent shape of fine lines and excellent resolution.

### BACKGROUND ART

Color filters usually include a transparent substrate made of glass, plastic sheet or the like on a surface of which is formed a matrix having a black color (black matrix) and further color patterns of three or more different hues, such as red (R), green (G), and blue (B), in the form of stripes or mosaic in order. The size of the patterns is on the order of 5 to 700 μm although it may vary depending on the utility of the color filter and respective colors. On the other hand, the precision of position of superposition is several μm to several tens μm and the patterns are produced by microfabrication technology, which provides high precision.

Representative production methods for color filters include a dyeing method, a printing method, a pigment dispersion method, an electroplating method and the like. Among these, in particular a pigment dispersion method, which repeats coating a photosensitive composition containing a color material on a transparent substrate, imageries exposing, developing and optionally curing the composition to form a color filter image, is high in precision of the position of color filter pixels and film thickness and shows less defects such as pinholes, so that it is widely adopted.

Generally, black matrices are arranged in the form of grids, stripes or mosaics between color patterns of R, G, and B and serve to increase contrast by suppressing mixing between colors or prevent the malfunction of TFT (thin film transistors) due to light leaking. For this reason, black matrices are required to have high light-shielding properties. Conventionally, it has been generally accepted to form black matrices from a film of metal such as chromium. This technique, which includes vapor depositing a metal such as chromium on a transparent substrate and etching the chromium layer through a step of photolithograph, provides thin, high light-shielding black matrices with high precision. However, at the same time, it has problems of high cost due to long production process and low productivity and environmental pollution attributable to wastewater discharged by etching treatment and the like.

Therefore, energetic studies have been made on techniques of forming a black matrix using a photosensitive resin that has dispersed therein a light-shielding pigment (resin black matrix) that is low in cost and causes no environmental pollution. However, the resin black matrix has problems as described hereinbelow so that it has not yet been put into practical application.

To exhibit in a resin black matrix light-shielding properties (high optical density) at the same level as that of a black matrix made of a film of metal such as chromium, it is necessary to increase the content of the light-shielding pigment or increase the film thickness.

A method in which the film thickness is increased is influenced by unevenness of the black matrix, so that the smoothness of evenness of colored pixels R, G and B is deteriorated. As a result, liquid cell gaps become nonuniform or orientation of liquid crystals is disturbed, thus causing a problem of a decrease in the ability of displaying and occurrence of breaking of transparent electrode (for example, ITO (indium tin oxide) film).

In a method in which the content of the light-shielding pigment is increased, carbon black, which is a light-shielding pigment, is dispersed in high concentrations, and this causes problems in that the viscosity of the resist composition increases and the sensitivity, developability, resolution, adhesion and so forth are aggravated, so that not only the productivity is decreased but also precision and reliability required for color filters fail to be obtained.

To increase the dispersability of carbon black in a black matrix resist composition in case where it is added in high concentrations, a technology has been developed by which carbon black is surface treated with a resin or the like or grafted with a resin. For example, JP-A-9-71733 (the term “JP-A” as used herein means an “unexamined published Japanese patent application”) and JP-A-10-330643 disclose methods for covering carbon black with an epoxy resin. On the other hand, JP-A-6-214385 and JP-A-10-160937 disclose methods for grafting carbon black with a resin. However, these methods involve cumbersome treatments and in addition the ratio of the resin in the resist solids content is high, causing the problem of a decrease in light-shielding property.

Further, studies have been made from the viewpoint of the dispersant used for dispersing carbon black. For example, in JP-A-2000-227654 (International Publication No. WO01/98831), a resin black matrix with a dispersant having a urethane bond has been proposed. However, practical blending amount of the dispersant is as much as 30 to 40 mass parts based on 100 mass parts of carbon black, so that it is difficult to increase light shielding effect.

As described above, since no photosensitive resin material has been realized that allows the resist composition to exhibit storage stability, sensitivity, developability, resolution, and adhesion of the under the conditions under which thin film property and high light-shielding property are satisfied, practical application of resin black matrix is obstructed.

An object of the present invention is to solve the above-mentioned problems and provide a color filter black matrix resist composition and carbon black dispersion that can readily form patterns having thin film property and high light-shielding property by a photolithographic method, have excellent storage stability, and provide sufficient sensitivity and resolution and further to produce such carbon black dispersion efficiently.

### DISCLOSURE OF THE INVENTION

As a result of intensive research, the inventors of the present invention have found that combining (A) a specified carbon black with (B) a copolymer having an amino group and/or its quaternary ammonium salt and using a carbon black dispersion subjected to dispersion treatment using a continuous annular type bead mill is suitable for forming a color filter black matrix having high light-shielding property and high resolution and further have found a carbon black dispersion composition and a black matrix resist composition having excellent dispersion stability.

That is, the present invention provides the following carbon black dispersion compositions for color filer black matrix resists and color filter black matrix resist compositions.
1. A carbon black dispersion composition for a color filter black matrix resist containing (A) a carbon black having an average primary particle diameter of 20 to 60 nm, a DBP oil absorption of 30 to 100 ml/100 g, a specific surface area by a BET method of 30 to 150 m²/g, and a concentration of carboxyl group on a particle surface of 0.2 to 1.0 mmol/m², (B) a copolymer having an amino group and/or its quaternary ammonium salt, and (C) an organic solvent.
2. The carbon black dispersion composition for a color filter black matrix resist according to 1 above, wherein the copolymer (B) having an amino group and/or its quaternary ammonium salt is obtained by copolymerizing monomers (i), (ii) and (iii) below:
(i) 10 to 85 mass parts of at least one (meth)acrylate monomer selected from (a) a (meth)acrylic acid alkyl ester containing an alkyl group having 1 to 18 carbon atoms, (b) a (meth)acrylic acid ester represented by formula (1) below 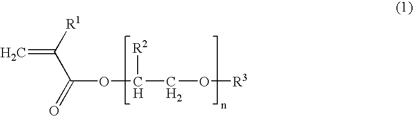
   (in the formula, R¹ and R², which may be the same or different, each represents a hydrogen atom or a methyl group, R³ represents an alkyl group having 1 to 18 carbon atoms, n is an integer of 1 to 50), (c) a (meth)acrylic acid ester represented by formula (2) below 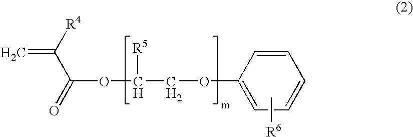
   (in the formula, R⁴ and R⁵, which may be the same or different, each represents a hydrogen atom or a methyl group, R⁶ represents an alkyl group having 1 to 18 carbon atoms, m is an integer of 1 to 50), and (d) a (meth)acrylic acid ester having a hydroxyl group,
(ii) 10 to 85 mass parts of an aminoalkyl (meth)acrylate monomer represented by formula (3) below 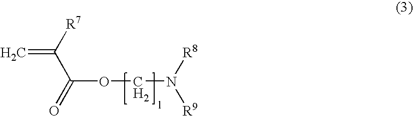
   (in the formula, R⁷ represents a hydrogen atom or a methyl group, R₈ and R⁹, which may be the same or different, each represents an alkyl group having 1 to 6 carbon atoms, 1 is an integer of 2 to 8), and/or a quaternary ammonium (meth)acrylate monomer represented by formula (4) below 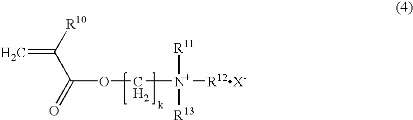
   (in the formula, R¹⁰ represents a hydrogen atom or a methyl group, R¹, R² and R³, which may be the same or different, each represents an alkyl group having 1 to 0.6 carbon atoms, a hydroxyalkyl group having 2 to 6 carbon atoms, an alkoxyalkyl group having 1 to 4 carbon atoms, a cycloalkyl group, an aralkyl group, a phenyl group, or a halogenated aryl group, X⁻ represents a halogen ion or an anion residue of an acid, and k is an integer of 2 to 8),
(iii) 5 to 80 mass parts of at least one selected from a polyalkyl (meth)acrylate macromonomer and a polystyrene macromonomer, having a (meth)acryloyl group at the terminal (provided that the total of (i) to (iii) is 100 mass parts).
3. The carbon black dispersion composition for a color filter black matrix resist according to 1 or 2 above, wherein the ratio of the carbon black (A) and the copolymer (B) having an amino group or its quaternary ammonium salt is (A):(B)=100:5 to 100:25 by mass ratio.
4. The carbon black dispersion composition for a color filter black matrix resist according to 1 above, wherein further comprising (D) a binder resin having a carboxyl group.
5. The carbon black dispersion composition for a color filter black matrix resist according to 1 above, wherein the dispersion is produced by using a continuous annular type bead mill.
6. A color filter black matrix resist composition comprising components (A), (B), (C), (D), (E), (F), and (G) below:
   (A) a carbon black having an average primary particle diameter of 20 to 60 nm, a DBP oil absorption of 30 to 100 ml/100 g, a specific surface area by a BET method of 30 to 150 m²/g, and a concentration of carboxyl group on a particle surface of 0.2 to 1.0 μmol/m²,
   (B) a copolymer having an amino group and/or its quaternary ammonium salt,
   (C) an organic solvent,
   (D) a binder resin having a carboxyl group,
   (E) an ethylenically unsaturated monomer,
   (F) a photopolymerization initiator, and
   (G) a multifunctional thiol compound having two or more mercapto groups.
7. The color filter black matrix resist composition according to 6 above, wherein the components other than the organic solvent (C) are contained in the following ratios:
(A) 40 to 80 mass %, (B) 4 to 50 mass %, (D) 10 to 50 mass %, (E) 3 to 45 mass %, (F) 2 to 45 mass %, and (G) 2 to 45 mass %.
8. The color filter black matrix resist composition according to 6 above, wherein the copolymer (B) having an amino group and/or its quaternary ammonium salt is a (meth)acrylic copolymer having a number average molecular weight of 4,000 to 100,000 obtained by copolymerizing monomers (i), (ii), and (iii) below:
(i) 10 to 85 mass parts of at least one (meth)acrylate monomer selected from (a) a (meth)acrylic acid alkyl ester containing an alkyl group having 1 to 18 carbon atoms, (b) a (meth)acrylic acid ester represented by formula (1) below 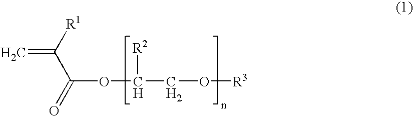
   (in the formula, the symbols in the formula have the same meanings as defined in 2 above), (c) a (meth)acrylic acid ester represented by formula (2) below 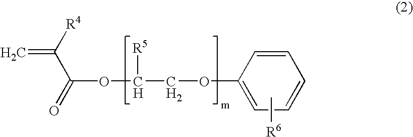
   (in the formula, the symbols have the same meanings as those in 2 above), and (d) a (meth)acrylic acid ester having a hydroxyl group,
(ii) 5 to 80 mass parts of an aminoalkyl (meth)acrylate monomer represented by formula (3) below 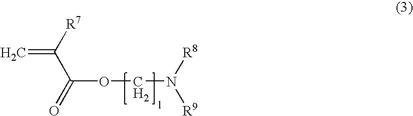
   (in the formula, the symbols have the same meanings as those in 2 above), and/or a quaternary ammonium (meth)acrylate monomer represented by formula (4) below 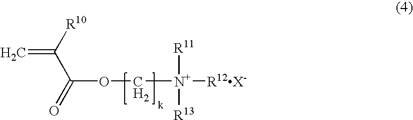
   (in the formula, the symbols have the same meanings as those in 2 above),
(iii) 5 to 80 mass parts of at least one selected from a polyalkyl (meth)acrylate macromonomer and a polystyrene macromonomer, having a (meth)acryloyl group at the terminal (provided that the total of (i) to (iii) is 100 mass parts).
9. The color filter black matrix resist composition according to 8 above, wherein the binder (D) having a carboxyl group has further an ethylenically unsaturated group.

### BRIEF DESCRIPTION OF THE DRAWING

FIG. 1 is a scanning electron micrograph of a portion of the resist of Example 16 having a line width of 10 μm, fabricated in evaluation of photosensitivity; and

FIG. 2 is a scanning electron micrograph of a portion of the resist of Comparative Example 5 having a line width of 10 μm, fabricated in evaluation of photosensitivity.

### DETAILED DESRIPTION OF THE INVENTION

Hereinafter, the present invention will be described in detail. In the following description, “part” and “%” that express ratios of amounts are based on mass unless otherwise indicated specifically.

In the present specification, “(meth)acrylic acid” is used to indicate either acrylic acid or methacrylic acid while the term “(meth)acryloyl” is used in a sense of either acryloyl or methacryloyl.

Further, color filter black matrix resist composition or its cured product is simply called as “resist” in some cases.

1. Carbon Black Dispersion

1-(1) Carbon Black (A)

In the present invention, carbon black is used as a light shielding material. Carbon black is black or grayish black powder generated by incomplete combustion or heat decomposition of organic substances and composed mainly of carbon. The micro state of carbon black varies depending on the production method. The production method includes a channel method, a furnace method, a thermal method, a lampblack method, an acetylene method and the like. In the present invention, it is important to use a carbon black that has a=DBP oil absorption of 30 to 100 ml/100 g, a specific surface area by a BET method of 30 to 150 m²/g, and a concentration of carboxyl group on a particle surface of 0.2 to 1.0 μmol/m².

The average primary particle diameter can be obtained by the following method. That is, electron microphotographs on a magnification of several tens thousands times are taken and diameters of several thousands of particles are measured, followed by determining a number average of the values.

DBP oil absorption can be obtained according to JIS K 6221 (1982).

Specific surface area can be obtained by a BET method (J. Amer. Chem. Soc., Vol. 60, p 309, 1938).

The concentration of carboxyl group on the surface of a particle can be obtained by a selective neutralization method (Rubber Chem. Technol., Vol. 36, p 729, 1963, Carbon, Vol. 1, p 451, p 456, 1963).

If the average primary diameter is less than 20 nm, the amount of the dispersant required increases and the amounts of binder resins and the like must be decreased, so that the strength of the resist film is decreased. On the other hand if the average primary diameter exceeds 60 nm, the problem of decreased resolution occurs. It is preferably 25 to 50 nm, more preferably 25 to 40 nm.

If the DBP oil absorption is less than 30 ml/100 g, the structure of carbon black is too small to disperse it while if the DBP absorption exceeds 100 ml/100 g, the structures of carbon black become too large and space between the structures is big, resulting in a reduced filling ratio per unit volume of carbon black particles, so that necessary light-shielding effect cannot be obtained in some cases. The DBP oil absorption is in the range of preferably 40 to 90 ml/100 g, more preferably 45 to 80 ml/100 g.

If the specific surface area by the BET method is less than 30 m²/g, the average particle diameter is big, so that resolution is decreased. If the specific surface area exceeds 150 m²/g, the amount of dispersant required increases and accordingly the amount of the binder and the like must be decreased, which results in a decrease in the strength of the resist film. The specific surface area is preferably 40 to 120 m²/g, more preferably 50 to 100 m²/g.

If the concentration of the carboxyl group is less than 0.2 μmol/m², the adsorption site of the amino group-containing high molecular dispersant is reduced, resulting in deteriorated dispersion stability of carbon black. On the contrary, if the concentration of the carboxyl group exceeds 1.0 μmol/m², the adsorption site of the amino group-containing high molecular dispersant increases and the amino group-containing high molecular dispersant is in a state that it is attached to the surface of the carbon black particle, so that dispersion stability due to entropy effect cannot be obtained. The concentration of the carboxyl group is in the range of preferably 0.3 to 0.9 μmol/m², more preferably 0.4 to 0.8 μmol/m².

Examples of the carbon black that can be used in the present invention include commercially available products, such as Raven 1040, Raven 1060, Raven 1080, Raven 1100, and Raven 1255 manufactured by Columbian Carbon Co., and Special Black 550, Special Black 350, Special Black 250, and Special Black 100 manufactured by Degussa, and so forth.

In the present invention, light-shielding materials other than carbon black may be used in combination with the above-mentioned carbon black. Examples of such light-shielding material include graphite, carbon nanotube, iron black, iron oxide black pigments, aniline black, cyanine black, titan black etc. In addition, three types, i.e., red, green, and blue organic pigments may be mixed and used as a black pigment.

1-(2) Amino Group-Containing Copolymer (B)

Copolymer having an amino group and/or its quaternary ammonium salt (sometimes referred to as “amino group-containing copolymer (B)”) used in the present invention is a (meth)acrylic copolymer having a number average molecular weight of 4,0000 to 100,000 including:
(i) (meth)acrylic acid alkyl ester having 1 to 18 carbon atoms, which is at least one (meth) acrylate monomer selected from a (meth)acrylic acid ester represented by formula (1) below 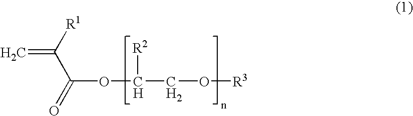
   (in the formula, R¹ and R², which may be the same or different, each represents a hydrogen atom or a methyl group, R³ represents an alkyl group having 1 to 18 carbon atoms, n is an integer of 1 to 50), a (meth)acrylic acid ester represented by formula (2) below 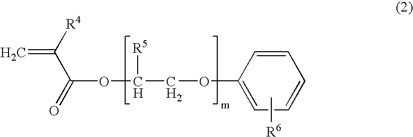
   (in the formula, R⁴ and R⁵, which may be the same or different, each represents a hydrogen atom or a methyl group, R⁶ represents an alkyl group having 1 to 18 carbon atoms, m is an integer of 1 to 50), and a (meth)acrylic acid ester having a hydroxyl group,
(ii) an aminoalkyl (meth)acrylate monomer represented by formula (3) below 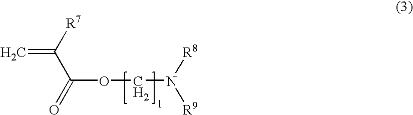
   (in the formula, R⁷ represents a hydrogen atom or a methyl group, R⁸ and R⁹/which may be the same or different, each represents an alkyl group having 1 to 6 carbon atoms, 1 is an integer of 2 to 8), and/or a quaternary ammonium (meth)acrylate monomer represented by formula (4) below 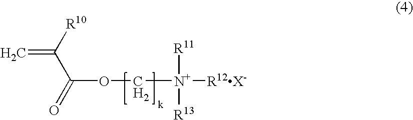
   (in the formula, R¹⁰ represents a hydrogen atom or a methyl group, R¹¹, R¹² and R¹³, which may be the same or different, each represents an alkyl group having 1 to 6 carbon atoms, a hydroxyalkyl group having 2 to 6 carbon atoms, an alkoxyalkyl group having 1 to 4 carbon atoms, a cycloalkyl group, an aralkyl group, a phenyl group, or a halogenated aryl group, X⁻ represents a halogen ion or an anion residue of an acid, and k is an integer of 2 to 8), and
(iii) at least one selected from a polyalkyl (meth)acrylate macromonomer and a polystyrene macromonomer, having a (meth)acryloyl group at the terminal,
   in which 10 to 85 mass parts of the monomer (i), 10 to 85 mass parts of the monomer (ii), and 5 to 80 mass parts of the monomer (iii) are copolymerized.

The monomer (i) is used for the purpose of increasing solubility in organic solvents compatibility or compatibility with other binder resins. Specific examples of the (meth)acrylic acid alkylester having 1 to 18 carbon atoms include methyl (meth)acrylate, ethyl (meth)acrylate, n-propyl (meth)acrylate, isopropyl (meth)acrylate, n-butyl (meth)acrylate, isobutyl (meth)acrylate, hexyl (meth)acrylate, 2-ethylhexyl (meth)acrylate, isodecyl (meth)acrylate, lauryl (meth)acrylate, and stearyl (meth)acrylate.

Specific examples of the (meth)acrylic acid ester represented by the formula (1) include methoxydiethylene glycol (meth)acrylate, methoxypolyethylene glycol (meth)acrylate, methoxypropylene glycol (meth)acrylate, methoxydipropylene glycol (meth)acrylate, methoxypolypropylene glycol (meth)acrylate, and n-butoxyethylene glycol (meth)acrylate.

Specific examples of the (meth)acrylic acid ester represented by the formula (2) include 2-phenoxyethyl (meth)acrylate, phenoxypolyethyleneglycol (meth)acrylate, and trioxyethylene nonylphenol (meth)acrylate.

Specific examples of the (meth)acrylic acid ester having a hydroxyl group include 2-hydroxyethyl (meth)acrylate, 2-hydroxypropyl (meth)acrylate, and 2-hydroxybutyl (meth)acrylate.

The monomer (ii) is used for the purpose of forming ion bonds with the carboxyl groups on the surface of the carbon black to give adsorption sites for carbon black. Specific examples of the aminoalkyl (meth)acrylate include N,N-dimethylaminoethyl (meth)acrylate, N,N-diethylaminoethyl (meth)acrylate, N-t-butylaminoethyl (meth)acrylate, N,N-dimethylaminopropyl (meth)acrylate, N,N-dimethylaminobutyl (meth)acrylate, N-propylaminoethyl (meth)acrylate, and N-butylaminoethyl (meth)acrylate.

The quaternary ammonium (meth)acrylate represented by the formula (4) is a monomer that contains one quaternary ammonium group and one (meth)acryloyl group in one molecule. Specific examples thereof include 2-hydroxy-3-(meth)acryloxypropyltrimethylammonium chloride, 2-hydroxy-3-(meth)acryloxypropyltriethanolammonium chloride, 2-hydroxy-3-(meth)acryloxypropyldimethylbenzylammonium chloride, 2-hydroxy-3-(meth)acryloxypropyldimethylphenylammonium chloride, (meth)acryloxyethyltrimethylammonium chloride, and (meth)acrylamidepropyltrimethylammonium chloride.

In the above description, an example is shown in which X⁻ is Cl⁻. However, the anion is not limited to Cl⁻ in the present invention and quaternary ammonium (meth)acrylate may be a monomer that includes Br⁻, I⁻, F⁻, HSO₄⁻, SO₄²⁻, NO₃⁻, PO₄³⁻, HPO₄³⁻, H₂PO₄⁻, C₆H₅SO₃⁻, OH⁻, etc.

The polyalkyl (meth)acrylate macromonomer containing a (meth)acryloyl group at a terminal of the monomer (iii) and polystyrene macromonomer are used in order to increase the dispersion stability of carbon black. Specific examples thereof include Macromonomer AA-6 (terminal group: methacryloyl group, segment: methyl methacrylate, number average molecular weight: 6,000, manufactured by To a Gosei Co., Ltd.), Macromonomer AW-6S (terminal group: methacryloyl group, segment: isobutyl acrylate, number average molecular weight: 6,000, manufactured by Toa Gosei Co., Ltd.), Macromonomer AB-6 (terminal group: methacryloyl group, segment: butyl acrylate, number average molecular weight: 6,000, manufactured by To a Gosei Co., Ltd.), macromonomer AS-6 (terminal group: methacryloyl group, segment: styrene, number average molecular weight: 6,000, manufactured by To a Gosei Co., Ltd.),

The copolymer having an amino group and/or its quaternary ammonium salt can be obtained by solution polymerization. Specifically, it is produced by polymerizing the monomer (i), the monomer (ii), and the monomer (iii) in a suitable inert solvent in the presence of a polymerization initiator. The reaction temperature is preferably 70 to 150° C., more preferably 80 to 130° C. A reaction time of 1 to 15 hours, particularly 4 to 8 hours is desirable.

The polymerization initiator includes azo compounds such as azobisisobutyronitrile and dimethylazobisisobutyrate, organic peroxides such as lauroyl peroxide, diisopropylbenzene hydroperoxide, etc.

The solvent are preferably those that can dissolve the produced copolymer having an amino group and/or its quaternary ammonium salt and are miscible with the carbon black dispersion and black matrix resist composition of the present invention. Specific examples thereof include aromatic solvents such as toluene and xylene, ketones solvents such as methyl isobutyl ketone and cyclohexanone, ester solvents such as ethyl acetate and butyl acetate, glycol solvents such as ethylene glycol ethyl ether, ethylene glycol n-butyl ether, propylene glycol monomethyl ether, ethylene glycol monoethyl ether acetate, and propylene glycol monomethyl ether acetate. These may be used singly or two or more of them may be used in combination.

If the monomer (i) is in an amount of less than 10 mass parts, the solubility in organic solvents and compatibility with the binder resin of the resist are deteriorated and applicable resins are limited. When the amount of the monomer (i) exceeds 85 mass parts, the dispersion speed and dispersion stability of carbon black are decreased. When the monomer (ii) is in an amount of less than 10 mass parts, the compatibility with carbon black is decreased, so that carbon black cannot be dispersed completely. When the monomer (ii) is in an amount exceeding 80 mass parts, the alkali developer resistance of the cured resist film is decreased. When the monomer (iii) is in an amount of less than 5 mass parts, carbon black cannot be dispersed completely. When the monomer (iii) is in an amount exceeding 80 mass parts, the dispersion speed of carbon black is rather decreased.

The average molecular weight of the monomer (iii) is preferably 2,000 to 20,000 in a weight average molecular weight in terms of polystyrene as measured by gel permeation chromatography (GPC). When this average molecular weight is lower than 2,000, the dispersion stability of pigments tends to be deteriorated. When the average molecular weight is higher than 20,000, the viscosity of the dispersant is too high to be practically usable.

The average molecular weight of the copolymer (B) having an amino group and/or its quaternary ammonium salt is preferably 5,000 to 200,000 in a weight average molecular weight in terms of polystyrene as measured by gel permeation chromatography (GPC) When the molecular weight is lower than 5,000, the physical properties of resist tend to be deteriorated. When the molecular weight is higher than 200,000, the viscosity of the carbon black dispersion becomes too high to be handled. For this reason, the number average molecular weight of the copolymer (B) having an amino group and/or its quaternary ammonium group is particularly preferably 10,000 to 100,000. The molecular weight can be easily controlled with a polymerization controlling agent such as an alkylmercaptan, etc.

1-(3) Organic Solvent (C)

The organic solvent is not particularly limited so far as the solvent can dissolve materials used in the present invention. For example, the organic solvent include ethers such as diisopropyl ether, ethyl isobutyl ether, and butyl ether, esters such as ethyl acetate, isopropyl acetate, (n-, sec-, tert-)butyl acetate, amyl acetate, ethyl 3-ethoxypropinate, methyl 3-methoxypropionate, ethyl 3-methoxypropionate, propyl 3-methoxypropionate, and butyl 3-metoxypropionate, ketones such as methyl ethyl ketone, diisobutyl ketone, diisopropyl ketone, ethyl amyl ketone, methyl butyl ketone, methyl hexyl ketone, methyl isoamyl ketone, methyl isobutyl ketone, and cyclohexanone, glycols such as ethylene glycolmonomethyl ether, ethylene glycol monoethyl ether, ethylene glycol diethyl ether, ethylene glycol monomethyl ether acetate, ethylene glycol monoethyl ether acetate, diethylene glycol monoethyl ether acetate, propylene glycol mono-t-butyl ether, propylene glycol monomethyl ether, propylene glycol monoethyl ether, propylene glycol monomethyl ether acetate, propylene glycol monoethyl ether acetate, dipropylene glycol monoethyl ether, dipropylene glycol monomethyl ether, dipropylene glycol monomethyl ether acetate, dipropylene glycol monoethyl ether acetate, ethylene glycol monobutyl ether, and tripropylene glycol methyl ether.

The organic solvent is preferably selected from those which can dissolve or disperse the respective components and have a boiling point in the range of 100 to 200° C., more preferably 120 to 170° C. These solvents may be used singly or in admixture.

1-(4) Binder Resin (D) Having a Carboxyl Group

In the present invention, the binder resin having a carboxyl group is a component that mainly determines various properties of the color filter black matrix resist, such as film strength, heat resistance, substrate adhesion, solubility in aqueous alkali solutions (alkali developability) and so forth and any binder resin may be used freely so far as it meets the required characteristics. As such binder resins, acrylic acid copolymers, epoxy (meth)acrylate resins, urethane (meth)acrylic resins and so forth may be exemplified.

(i) Acrylic Acid Copolymer Having a Carboxyl Group

The acrylic acid copolymer having a carboxyl group and an ethylenically unsaturated group is obtained by copolymerizing (a) a carboxyl group-containing ethylenically unsaturated monomer and (b) another ethylenically unsaturated monomer other than the monomer (a) above. To further increase the photosensitivity, ethylenically unsaturated groups may be imparted to the side chain by reacting a part of carboxyl groups on the side chain of the acrylic acid copolymer obtained by copolymerizing the above-mentioned monomers with the epoxy group of a compound having an epoxy group and an ethylenically unsaturated group in one molecule, such as glycidyl (meth)acrylate, 3,4-epoxycyclohexylmethyl (meth)acrylate, or allyl glycidyl ether, or by using a monomer having a hydroxyl group such as hydroxyethyl methacrylate as the unsaturated monomer (b) of the acrylic copolymer and reacting a part of or whole hydroxyl groups thereof with a compound having an isocyanate group and an ethylenically unsaturated group in one molecule such as 2-methacryloyloxyisocyanate.

The carboxyl group-containing ethylenically unsaturated monomer (a) is used in order to impart alkali developability to the acrylic acid copolymer. Specific examples of the carboxyl group-containing ethylenically unsaturated monomer include (meth)acrylic acid, 2-(meth)acryloyloxyethylsuccinic acid, 2-(meth)acryloyloxyethylphthalic acid, (meth)acryloyloxyethylhexahydrophthalic acid, (meth)acrylic acid dimer, maleic acid, crotonic acid, itaconic acid, fumaric acid, etc.

The ethylenically unsaturated monomer (b) other than the monomer (a) ‘above is u’ sed for the purpose of controlling the strength of the resist film and the dispersability of the pigment. Specific examples thereof include vinyl compounds such as styrene, α-methylstyrene, (o, m, p-)hydroxystyrene, and vinyl acetate, (meth)acrylates such as methyl (meth)acrylate, ethyl (meth)acrylate, n-propyl (meth)acrylate, isopropyl (meth)acrylate, n-butyl (meth)acrylate, tert-butyl (meth)acrylate, n-hexyl (meth)acrylate, cyclohexyl (meth)acrylate, benzyl (meth)acrylate, phenoxyethyl (meth)acrylate, isobornyl (meth)acrylate, and tetrahydrofurfuryl (meth)acrylate, (meth)acrylonitrile, glycidyl (meth)acrylate, allyl glycidyl ether, 2-hydroxyethyl (meth)acrylate, 2-hydroxypropyl (meth)acrylate, N,N-dimethylaminoethyl (meth)acrylate, trifluoroethyl acrylate, 2,2,3,3-tetrafluoropropyl (meth)acrylate, and perfluorooctylethyl (meth)acrylate, and compounds having an amide group, such as (meth)acrylamide, N,N-dimethyl (meth)acrylamide, N,N-diethyl (meth)acrylamide, N-methyl (meth)acrylamide, N-ethyl (meth)acrylamide, N-isopropyl (meth)acrylamide, N-vinylpyrrolidone, N-vinylcaprolactam, and N-(meth)acryloylmorpholine.

Copolymerization ratio of the carboxyl group-containing ethylenically unsaturated monomer (a) to the ethylenically unsaturated monomer (b) other than the one described in (a) above is preferably 5:95 to 60:40, more preferably 10:90 to 50:50, in mass ratio. If the copolymerization ratio of (a) is less than 5, the alkali developabililty is decreased so that it becomes difficult to form patterns. On the other hand, if the copolymerization ratio of (a) exceeds 60, alkali development of the photocured portion too readily proceeds so that it becomes difficult to maintain the line width of the patterns at a constant value.

A preferred molecular weight of the acrylic acid copolymer having a carboxyl group and an ethylenically unsaturated group is in the range of 1,000 to 500,000, preferably 3,000 to 200,000 in a weight average molecular weight in terms of polystyrene obtained by GPC. If the molecular weight is less than 1,000, the film strength after curing decreases considerably. On the other hand, if the molecular weight exceeds 500,000, the alkali developability decreases considerably.

The above-mentioned acrylic acid copolymer may be used as mixtures of two or more of them.

(ii) Epoxy (meth)acrylate Resin Having a Carboxyl Group

The epoxy (meth)acrylate compound having a carboxyl group used in the present invention is not particularly limited; however, an epoxy (meth)acrylate compound obtained by reacting a reaction product between an epoxy compound and an unsaturated group-containing monocarboxylic acid with acid anhydride is suitable.

The epoxy compounds are not particularly limited and include epoxy compounds such as a bisphenol A type epoxy compound, a bisphenol F type epoxy compound, a bisphenol S type epoxy compound, a phenol novolak type epoxy compound, a cresol novolak type epoxy compound, or an aliphatic epoxy compound. These may be used singly or in combinations of two or more of them.

Examples of the unsaturated group-containing monocarboxylic acid include (meth)acrylic acid, 2-(meth)acryloyloxyethylsuccinic acid, 2-(meth)acryloyloxyethylphthalic acid, (meth)acryloyloxyethylhexahydrophthalic acid, (meth)acrylic acid dimer, β-furfurylacrylic acid, β-styrylacrylic acid, cinnamic acid, crotonic acid, and α-cyanocinnamic acid. Further examples thereof include half ester compounds that are reaction products between a hydroxyl group-containing acrylate and a saturated or unsaturated dibasic acid anhydride, half ester compounds that are reaction products between unsaturated group-containing monoglycidyl ether and a saturated or unsaturated dibasic acid anhydride. These unsaturated group-containing monocarboxylic acids may be used singly or in combinations of two or more of them.

Examples of the acid anhydride include dibasic acid anhydrides such as maleic acid anhydride, succinic acid anhydride, itaconic acid anhydride, phthalic acid anhydride, tetrahydrophthalic acid anhydride, hexahydrophthalic anhydride, methylhexahydrophthatlic acid anhydride, endomethylenetetrahydrophthalic acid anhydride, methylendomethylenetetrahydrophthalic acid anhydride, chlorendic acid anhydride and methyltetrahydrophtalic acid anhydrate, aromatic polybasic carboxylic acid anhydrides such as trimellitic acid anhydride, pyromellitic acid anhydride and benzophenonetetracarboxylic acid dianhydride, and polybasic carboxylic acid anhydride derivatives such as 5-(2,5-dioxotetrahydrofuryl)-3-methyl-3-cyclohexene-1,2-dicarboxylic acid anhydride, endobicyclo-[2.2.1]-hept-5-ene-2,3-dicarboxylic acid anhydride. These may be used singly or in combinations of two or more.

The molecular weight of the epoxy (meth)acrylate compound having a carboxyl group thus obtained is not particularly limited; however, the weight average molecular weight in terms of polystyrene obtained by GPC is preferably 1,000 to 40,000, more preferably 2,000 to 5,000.

Further, acid value (which means acid value of solid contents measured according to JIS K0070, hereinafter the same will apply) of the above-mentioned epoxy (meth)acrylate compound is 10 mgKOH/g or more, more preferably in the range of 45 mgKOH/g to 160 mgKOH/g, and particularly preferably in the range of 50 mgKOH/g to 140 mgKOH/g in view of well balanced alkali solubility and alkali resistance of the cured resist film. If the acid value is smaller than 10 mgKOH/g, the alkali solubility is deteriorated. On the contrary, if it is too large, this may be a factor that deteriorates the characteristics of the cored resist film, such as alkali resistance.

(iii) Urethane (meth)acrylate Resin Having a Carboxyl Group

The urethane (meth)acrylate resin having carboxyl group used in the present invention is a binder resin that is more flexible than acrylic acid copolymer and epoxy (meth)acrylate and is used in applications where flexibility and bending resistance are required.

The urethane (meth)acrylate resin having a carboxyl group is a compound containing a unit derived from (meth)acrylate having a hydroxyl group, a unit derived from a polyol, and a unit derived from a polyisocyanate as constituent units. More specifically, both terminals of the resin consist of units derived from (meth)acrylate having hydroxyl groups and the portion between the terminals is constituted by repeating units consisting of a unit derived from a polyol and a unit derived from a polyisocyanate connected to each other through a urethane bond and carboxyl groups exist in the repeating units.

That is, the above-mentioned urethane (meth)acrylate resin having a carboxyl group is represented by
-(ORbO-OCNHRcNHCO)ₙ-
(in the formula, ORbO is a dehydrogenated residue of a polyol, Rc is a deisocyanato residue of a polyisocyanate, and n is an integer).

The urethane (meth)acrylate resin having a carboxyl group can be produced by reacting at least a (meth)acrylate having a hydroxyl group, a polyol, and a polyisocyanate. Here, it is necessary to use a compound having a carboxyl group for at least one of the polyol and the polyisocyanate. It is preferable that a polyol having a carboxyl group is used. In his manner, by using a compound having a carboxyl group as a polyol and/or a polyisocyanate, a urethane (meth)acrylate resin in which a carboxyl group is present in Rb or Rc can be produced. Note that in the above-mentioned formula, n is preferably about 1 to about 200, more preferably 2 to 30. When n is in such a range, the cured resist film has more excellent flexibility.

In addition, in the case where two or more kinds of at least one of polyol and polyisocyanate are used, repeating units represent a plurality of kinds. The regularity of the plural units include completely random, block, localization and so forth, from which appropriate one may be selected depending on the purpose.

Examples of the (meth)acrylate having a hydroxyl group include 2-hydroxyethyl (meth)acrylate, hydroxypropyl (meth)acrylate, hydroxybutyl (meth)acrylate, caprolactone or alkylene oxide adducts of each of the above-mentioned (meth)acrylates, glycerol mono(meth)acrylate, glycerol di(meth)acrylate, glycidyl methacrylate-acrylic acid adduct, trimethylolpropane mono(meth)acrylate, trimethylol di(meth)acrylate, pentaerythritol tri(meth)acrylate, dipentaerythritol penta(meth)acrylate, and trimethylolpropane-alkylene oxide adduct-di(meth)acrylate.

These (meth)acrylates having a hydroxyl group may be used singly or in combination of two or more of them. Among these, 2-hydroxyethyl (meth)acrylate, hydroxypropyl (meth)acrylate, and hydroxybutyl (meth)acrylate, are preferable and 2-hydroxyethyl (meth)acrylate is more preferable. When 2-hydroxyethyl (meth)acrylate is used, synthesis of the urethane (meth)acrylate resin having a carboxyl group is easier than otherwise.

The polyol used in the present invention may be polymer polyols and/or dihydroxyl compounds. Examples of the polymer polyol include polyether diols such as polyethylene glycol, polypropylene glycol, and polytetramethylene glycol, polyester polyols obtained from esters of polyhydric alcohols and polybasic acids, polycarbonate diols containing a unit derived from hexamethylene carbonate, pentamethylene carbonate, etc. as a constituent unit, polylactone diols such as polycaprolactone diol and polybutyrolactone diol.

Further, in the case where a polymer polyol having a carboxyl group is used, a compound which has been synthesized by allowing a tribasic or more polybasic acid such as trimellitic acid (anhydride) to exist, for example, upon the synthesis of the above-mentioned polymer polyol so that the carboxyl group remains may be used.

The polymer polyols may be used singly or two or more of them may be used in combination. When polymer polyols having a number average molecular weight of 200 to 2,000 are used, cured resist films have more excellent flexibility.

Compounds that can be used as the dihydroxyl compounds include branched or liner compounds having-two alcoholic hydroxyl groups. In particular, it is preferable that dihydroxy aliphatic carboxylic acids having a carboxyl group be used. Examples of such dihydroxyl compound include dimethylolpropionic acid and dimethylolbutanoic acid. Use of the dihydroxy aliphatic carboxylic acid having a carboxyl group allows a carboxyl group to exist in the urethane (meth)acrylate resin without difficulty.

The dihydoxyl compounds may be used singly or two or more of them may be used in combination or they may be used together with the polymer polyol.

Further, in the case where the polymer polyol having a carboxyl group is used in combination or the polyisocyanate mentioned below having a carboxyl group is used, dihydroxyl compounds having no carboxyl group, such as ethylene glycol, diethylene glycol, propylene glycol, 1,4-buanediol, 1,3-butanediol, 1,5-pentanediol, neopentyl glycol, 3-methyl-1,5-pentanediol, 1,6-hexanediol, and 1,4-cyclohexanedimethanol may be used.

The polyisocyanate used in the present invention specifically include 2,4-toluene diisocyanate, 2,6-toluene diisocyanate, isophorone diisocyanate, hexamethylene diisocyanate, diphenylmethylene diisocyanate, (o, m, or p)-xylene diisocyanate, methylenebis (cyclohexyl isocyanate), trimethylhexamethylene diisocyanate, cyclohexane-1,3-dimethylene diisocyanate, cyclohexane-1,4-dimethylene diisocyanate, and 1,5-naphthalene diisocyanate. These polyisocyanates may be used singly or in combination. Further, the polyisocyanate having a carboxyl group may be used.

The molecular weight of the urethane (meth)acrylate resin having a carboxyl group used in the present invention is not particularly limited; a weight average molecular weight in terms of polystyrene as measured by GPC is 1,000 to 40,000, more preferably 8,000 to 30,000. The acid value of the above-mentioned urethane (meth)acrylate is preferably 5 to 150 mgKOH/g, and more preferably 30 to 120 mgKOH/g.

If the number average molecular weight of the urethane (meth)acrylate having a carboxyl group is less than 1,000, the elongation and strength of the cured resist film may be deteriorated. On the other hand, if the molecular weight exceeds 40,000, the cured resist film becomes harder and there is a risk that the flexibility is decreased. If the acid value is less than 5 mgKOH/g, the alkali solubility of the resist may be aggravated in some cases while if the acid value exceeds 150 mgKOH/g, the alkali resistance, etc. of the cured resist film may be deteriorated in some cases.

2. Color Filter Black Matrix Resist Composition

2-(1) Ethylenically Unsaturated Monomer (E)

The ethylenically unsaturated monomer (E) is blended for the purpose of performing polymerization and crosslinking with radicals generated by the photopolymerization initiator upon irradiation of light to insolubilize the composition in alkali developers.

Preferably, (meth)acrylic acid esters are used as the ethylenically unsaturated monomer (E). Specific examples thereof include alkyl (meth)acrylates such as methyl (meth)acrylate, ethyl (meth)acrylate, propyl (meth)acrylate, butyl (meth)acrylate, isobutyl (meth)acrylate, sec-butyl (meth)acrylate, tert-butyl (meth)acrylate, hexyl (meth)acrylate, octyl (meth)acrylate, isooctyl (meth)acrylate, 2-ethylheyxyl (meth)acrylate, decyl (meth)acrylate, lauryl (meth)acrylate, and stearyl (meth)acrylate;
alicyclic(meth)acrylates such as cyclohexyl (meth)acrylate, bornyl (meth)acrylate, isobornyl (meth)acrylate, dicyclopentenyl (meth)acrylate, and dicyclopentenyloxyethyl (meth)acrylate;
aromatic (meth)acrylates such as benzyl (meth)acrylate, phenyl (meth)acrylate, phenylcarbitol (meth)acrylate, nonylphenyl (meth)acrylate, nonylphenylcarbitol (meth)acrylate, and nonylphenoxy (meth)acrylate;
(meth)acrylates having a hydroxyl group, such as 2-hydroxyethyl (meth)acrylate, hydroxypropyl (meth)acrylate, hydroxybutyl (meth)acrylate, butanediol mono(meth)acrylate, glycerol (meth)acrylate, polyethylene glycol (meth)acrylate, or glycerol di(meth)acrylate;
(meth)acrylates having an amino group, such as 2-dimethylaminoethyl (meth)acrylate, 2-diethylaminoethyl (meth)acrylate, and 2-tert-butylaminoethyl (meth)acrylate;
(meth)acrylates having a phosphorus atom, such as methacryloxyethyl phosphate, bis(methacryloxy)ethyl phosphate, and methacryolxyethyl phenyl acid phosphate (phenyl P), etc.;
di(meth)acrylates such as ethylene glycol di(meth)acrylate, diethylene glycol di(meth)acrylate, triethylene glycol di(meth)acrylate, tetraethylene glycol di(meth)acrylate, polyethylene glycol di(meth)acrylate, propylene glycol di(meth)acrylate, dipropylene glycol di(meth)acrylate, tripropylene glycol di(meth)acrylate, 1,4-butanediol di(meth)acrylate, 1,3-butanediol di(meth)acrylate, neopentyl glycol di(meth)acrylate, 1,6-hexanediol di(meth)acrylate;
poly(meth)acrylates such as trimethylolpropane tri(meth)acrylate, pentaerythritol tri(meth)acrylate, and dipentaerythritol hexa(meth)acrylate;
modified polyol polyacrylates such as 4 mol ethylene oxide-added bisphenol S diacrylate, 4 mol ethylene oxide-added bisphenol A diacrylate, fatty acid-modified pentaerythritol diacrylate, 3 mol propylene oxide-added trimethylolpropane triacrylate, and 6 mol propylene oxide-added trimethylolpropane triacrylate;
polyacrylates having an isocyanuric acid skeleton, such as bis(acryloyloxyethyl) monohydroxyethyl isocyanurate, tris(acryloyloxyethyl) isocyanurate, and ε-caprolactone-added tris(acryloyloxyethyl) isocyanurate;
polyester acrylates such as α,ω-diacryloyl-(bisethylene glycol) phthalate, and α,ω-tetraacryloyl-bis(trimethylolpropane)-tetrahydrophthalate;
glycidyl (meth)acrylate;
allyl (meth)acrylate;
ω-hydroxyhexanoyloxyethyl (meth)acrylate;
polycaprolactone (meth)acrylate;
(meth)acryloyloxyethyl phthalate;
(meth)acryloyloxyethyl succinate;
2-hydroxy-3-phenoxypropyl acrylate;
phenoxyethyl acrylate and the like.

In addition, N-vinyl compounds such as N-vinylpyrrolidone, N-vinylformamide, and N-vinylacetamide may be preferably used.

Preferred among these are poly(meth)acrylates such as trimethylolpropane tri(meth)acrylate, pentaerythritol tri(meth)acrylate, and dipentaerythritol hexa(meth)acrylate because high photosensitivity is obtained.

2-(2) Photopolymerization Initiator (F)

In the present invention, the photopolymerization initiator (F) refers to a compound alone or a combination of the compound with a sensitizer, where the compound is excited with an active light such as ultraviolet rays, visible light, and (near) infrared rays to generate radicals, thereby starting the polymerization of the ethylenically unsaturated bonds. The photopolymerization initiator used in the black matrix resist composition of the present invention is required to generate radicals under high light-shielding conditions, so that one having high photosensitivity is used. Such a photopolymerization initiator includes (a) hexaarylbiimidazole compounds and (b) aminoacetophenone compounds.

Specific examples of the hexaaryl biimidazole compound (a) include
2,2′-bis(o-chlorophenyl)-4,4′,5,5′-tetraphenyl-1,2′-biimidazole,
2,2′-bis(o-bromophenyl)-4,4′,5,5′-tetraphenyl-1,2′-biimidazole,
2,2′-bis(o-fluorophenyl)-4,4′,5,5′-tetraphenyl-1,2′-biimidazole,
2,2′-bis(o,p-dichlorophenyl)-4,4′,5,5′-tetraphenyl-1,2′-biimidazole, etc. However, since the thermal decomposition product generated upon post-baking of the resist is low sublimating, it is preferable to use hexaaryl biimidazole compounds represented by formula (5) below because unnecessary crystals hardly attach to a ventilation duct.

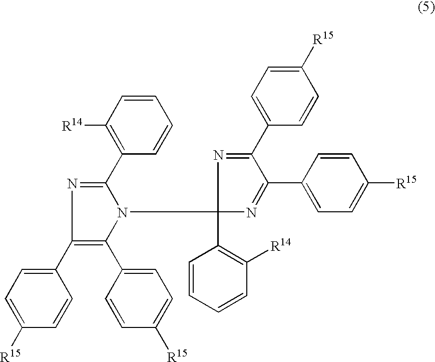

In formula (5) above, R¹⁴ represents a halogen atom and R¹⁵ represents an alkyl group which may have a substituent having 1 to 4 carbon atoms, or an alkoxy group which may have a substituent having 1 to 4 carbon atoms.

Among the hexaarylbiimidazole compound represented by the formula (5) above, particularly preferable examples thereof include
2,2′-bis(2-chlorophenyl)-4,4′,5,5′-tetrakis(4-methylphenyl)-1,2′-biimidazole.

Specific examples of the aminoacetophenone compound (b) include
2-methyl-1-[(4-methylthio)phenyl]-2-morpholino-propan-1-one and
2-benzyl-2-dimethylamino-1-(4-morpholinophenyl)-butanone-1.

When the hexaaryl biimidazole compound (a) and the aminoacetophenone compound (b) are used, a sensitizer may be blended in order to increase the sensitivity. Specifically, use may be made of benzophenone compounds such as benzophenone, 2,4,6-trimethylbenzophenone, 4-phenylbenzophenone, 4-benzoyl-4′-methyldiphenyl sulfide, 4,4′-bis(dimethylamino)benzophenone, and 4,4′-bis(diethylamino)benzophenone, thioxanthone-based compounds such as thioxanthone, 2-methylthioxanthone, 2,4-dimethylthioxanthone, 2,4-diethylthioxanthone, isopropylthioxanthone, 2,4-diisopropylthioxanthone, and 2-chlorothioxanthone, ketocoumarin-based compounds such as 3-acethylcoumarin, 3-acetyl-7-diethylaminocoumarin, 3-benzoylcoumarin, 3-benzoyl-7-diethylaminocoumarin, 3-benzoyl-7-methoxycoumarin, 3,3′-carbonylbis(7-methoxycoumarin) and 3,3′-carbonylbis(5,7-dimethoxycoumarin).

In the present invention, photopolymerization initiator other than those described above may be used. Such photopolymerization initiators include a combination of the sensitizer and organoborate-based compounds described in JP-A-2000-249822 (U.S. Pat. No. 6,455,207), etc., titanocene compounds described in JP-A-4-221958, JP-A-4-21975, etc., and triazine compounds described in JP-A-10-253815, etc. 2-(3) Multifunctional thiol compound (G) having two or more mercapto groups

In the present invention, a multifunctional thiol compound having two or more mercapto groups in one molecule can be used as a chain transfer agent which is a part of the photopolymerization initiator. By the addition of the multifunctional thiol, the inhibition of polymerization by oxygen is suppressed and uniform photocuring reaction can occur under high light-shielding conditions. Specific examples of such a multifunctional thiol compound include hexanedithiol, decanedithiol, 1,4-butanediol bis(3-mercaptopropionate), 1,4-butanediol bis(mercaptoacetate), ethylene glycol bis(mercaptoacetate), ethylene glycol bis(3-mercaptopropionate), trimethylolpropane tris(mercaptoacetate), trimethylolpropane tris(3-mercaptopropionate), pentaerythritol tetrakis(mercaptoacetate), and pentaerythritol tetrakis(3-mercaptopropionate).

However, in the case of the multifunctional thiols having a primary mercapto group, the mercapto group reacts with an ethylenically unsaturated group such as a (meth)acryloyl group may react in some cases, resulting in a decrease in sensitivity after storage. Accordingly, for the purpose of obtaining further storage stability, it is preferable in the present invention that a multifunctional thiol having a mercapto group containing group of formula (6) below.
—(CH₂)ⱼC(R¹⁶)(R¹⁷)(CH₂)ₕSH (6)
(in the formula, R¹⁶ and R¹⁷ each independently represent a hydrogen atom or an alkyl group having 1 to 10 carbon atoms, provided that one of R¹⁶ and R¹⁷ is an alkyl group, j is 0 or an integer of 1 or 2, and h is 0 or 1.)

Specific examples of the multifunctional thiol compound having a mercapto group-containing group of formula (6) include ethylene glycol bis(3-mercaptobutyrate), 1,2-propylene glycol bis(3-mercaptobutyrate), diethylene glycol bis(3-mercaptobutyrate), 1,4-butanediol bis(3-mercaptobutyrate), 1,8-octanediol bis(3-mercaptobutyrate), trimethylolpropane tris(3-mercaptobutyrate), pentaerythritol tetrakis(3-mercaptobutyrate), dipentaerythritol hexakis(3-mercaptobutyrate), ethylene glycol bis(2-mercaptopropionate), 1,2-propylene glycol bis(2-mercaptopropionate), diethylene glycol bis(2-mercaptopropionate), 1,4-butanediol bis(2-mercaptopropionate), 1,8-octanediol bis(2-mercaptopropionate), trimethylolpropane tris(2-mercaptopropionate), pentaerythritol tetrakis(2-mercaptopropionate), dipentaerythritol hexakis(2-mercaptopropionate), ethylene glycol bis(3-mercaptoisobutyrate), 1,2-propylene glycol bis(3-mercaptoisobutyrate), diethylene glycol bis(3-mercaptoisobutyrate), 1,4-butanediol bis(3-mercaptoisobutyrate), 1,8-octanediol bis(3-mercaptoisobutyrate), trimethylolpropane tris(3-mercaptoisobutyrate), pentaerythritol tetrakis(3-mercaptoisobutyrate), dipentaerythritol hexakis (3-mercaptoisobutyrate), ethylene glycol bis(2-mercaptoisobutyrate), 1,2-propylene glycol bis(2-mercaptoisobutyrate), diethylene glycol bis(2-mercaptoisobutyrate), 1,4-butanediol bis(2-mercaptoisobutyrate), 1,8-octanediol bis(2-mercaptoisobutyrate), trimethylolpropane tris(2-mercaptoisobutyrate), pentaerythritol tetrakis(2-mercaptoisobutyrate), dipentaerythritol hexakis(2-mercaptoisobutyrate).

In the black matrix resist composition of the present invention, the contents of the respective components other than the organic solvent are as follows.

The carbon black (A) having an average primary particle diameter of 20 to 60 nm, a DBP oil absorption of 30 to 100 ml/100 g, a specific surface area by a BET method of 30 to 150 m²/g, and a concentration of carboxyl group on a particle surface of 0.2 to 1.0 μnol/m² is contained in an amount of preferably 40 to 80 mass %, more preferably 45 to 65 mass %. If the content is less than 40 mass %, necessary light shielding effect cannot be obtained while above 80 mass %, the dispersion stability is decreased so that the strength of the resist film may in some cases be decreased.

The content of the copolymer (B) having an amino group and/or its quaternary ammonium salt is preferably 4 to 50 mass %, more preferably 6 to 12 mass %. If the content is less than 4 mass %, sufficient dispersion stability of carbon black is not obtained while if the content exceeds 50 mass %, the photosensitivity may be decreased or physical properties of the resist film may be decreased in some cases.

The content of the binder resin (D) having a carboxyl group is preferably 10 to 50 mass %, more preferably 12 to 25 mass %. If the content of the binder resin having a carboxyl group is less than 10 mass %, the durability of the resist film may be decreased in some cases. If the content exceeds 50 mass %, sufficient light-shielding effect may not be obtained in some cases.

The content of the ethylenically unsaturated monomer (E) is preferably 3 to 45 mass %, more preferably 5 to 15 mass %. If the content is less than 3 mass %, no sufficient photosensitivity can be obtained while if the content exceeds 45 mass %, no sufficient photosensitivity cannot be obtained in some cases.

The content of the photopolymerization initiator (F) is preferably 2 to 45 mass %, more preferably 5 to 12 mass %. If the content is less than 2 mass %, no sufficient photosensitivity can be obtained while if the content exceeds 45 mass %, the durable photosensitivity of the resist film can be obtained while if the content exceeds 45 mass %, the durable photosensitivity of the resist film cannot be obtained in some cases.

The content of the multifunctional thiol compound (G) having two or more mercapto groups is preferably 2 to 45 mass %, more preferably 5 to 12 mass %. If the content is less than 2 mass %, no sufficient photosensitivity can be obtained while if the content exceeds 45 mass %, it is possible that the thin line becomes thicker than the width of the photomask.

In the present invention, in addition to these essential components, adhesion improvers, leveling agents, development improvers, antioxidants, thermal polymerization inhibitors and so forth may be advantageously added.

3. Production Method for Carbon Black Dispersion

The carbon black-dispersion of the present invention can be produced by preliminarily blending the above-mentioned carbon black (A), dispersant (B), organic solvent (C), and/or binder resin (D), premixing them by use of a disperser or the like, and then subjecting the resultant to pulverization and dispersion treatment using a roll mill such as a two-roll mill or a three-roll mill, a ball mill such as a ball mill or a vibrating ball mill, a paint conditioner, or a bead mill such as a paint conditioner, a continuous disk type bead mill or a continuous annular type bead mill. A continuous annular type bead mill is particularly preferable in that pulverization and dispersion is achieved in short times, particle size distribution after the dispersion is sharp, it is easy to control the temperature during pulverization and dispersion so that the denaturation of the dispersion can be prevented.

The continuous annular type bead mill is of a structure having a vessel (cylindrical body) provided with an inlet and an outlet for a material and a rotor (rotating body) formed with grooves for stirring beads, inserted into the vessel. In a gap portion between the double cylinders, beads are imparted movement by the rotation of the rotor to effect pulverization, shearing and grinding, so that the black pigment can be efficiently pulverized and dispersed. The sample is introduced through the inlet on one end of the vessel and converted into fine particles and discharged through the outlet on the side opposite to the inlet part and this procedure is repeated until a necessary particle size distribution can be obtained. The time in which the sample is substantially subjected to pulverizing and dispersing treatment within the vessel is called retention time.

Examples of such continuous annular type mead mill include Spike Mill (trade name) manufactured by Inoue Seisakusho Co., Ltd. and OB-Mill (trade name) manufactured by Turbo Industry Co., Ltd.

Preferable dispersion conditions for the continuous annular type bead mill are as follows. The size (diameter) of beads to be used is preferably 0.2 to 1.5 mm, more preferably 0.4 to 1.0 mm. If the size of the beads is less than 0.2 mm, the weight of a single bead becomes too small so that the pulverization energy a single bead has becomes low so that pulverization of the pigment is difficult to proceed. If the size of the beads exceeds 1.5 mm, the number of collisions between the beads is reduced so that it becomes difficult to perform pulverization of carbon black in a short time.

The material of bead is preferably a ceramic such as zirconia or alumina or stainless steel having specific gravity of 4 or more since the pulverization efficiency is high.

The peripheral speed of the rotor is preferably 5 to 20 m/second, more preferably 8 to 15 m/second. If the peripheral speed is less than 5 m/second, the pulverization or dispersion of the pigment cannot be performed efficiently. If the peripheral speed of the rotor exceeds 20 m/second, the temperature of the pigment dispersion increases too high to cause denaturation such as viscosity increase occurs and therefore is not preferable.

The temperature during dispersing is preferably in the range of 10 to 60° C., more preferably room temperature to 50° C. The temperature of less than 10° C. is not preferable since the moisture in the atmosphere is mixed in the dispersion due to dew formation. On the other hand, the temperature exceeding 60° C. is not preferable either, since the temperature of the pigment dispersion is elevated too high due to heat of friction, causing denaturation such as an increase in viscosity.

The retention time is preferably 1 to 30 minutes, more preferably 3 to 20 minutes. If the retention time is shorter than 1 minute, pulverizing and dispersing treatment be comes insufficient while if the retention time exceeds 30 minutes, denaturation of the dispersion occurs, resulting in an increase in viscosity.

4. Production Method for Black Matrix Resist

To produce the color filter black matrix resist composition of the present invention, the carbon black dispersion obtained by the above-mentioned dispersion treatment, the above-mentioned components necessary for the black matrix resist composition are added and mixed to form a homogeneous solution. In the production process, often fine dust contaminates the photosensitive solution; therefore, it is desirable that the black matrix resist composition is subjected to filtration treatment by using a filer or the like.

5. Production Method for Color Filter

Subsequently, production method for a color filter using the black matrix resist composition of the present invention will be described.

First, the production method for color filters using the color filter black matrix resist composition of the present invention will be described taking an example of a color filter for a liquid crystal display that laminated a black matrix resist composition, pixels, and a protective film in this order.

The color filter black matrix resist composition of the present invention is coated onto a transparent substrate. Then, after the solvent is dried in an oven or the like, the resultant is exposed through a photomask and developed to form a black matrix pattern, followed by post-baking to complete a black matrix.

Here, the transparent substrate is not particularly limited and inorganic glasses such as silica glass, borosilicate glass, and lime soda glass coated with silica on its surface, films or sheets of polyesters such as polyethylene terephthalate, polyolefins such as polypropylene and polyethylene, thermoplastic plastics such as polycarbonate, polymethyl methacrylate, and polysulfones, thermosetting resins such as epoxy resins and polyester resins are preferably used. Such transparent substrates may have been subjected to corona discharge treatment, ozone treatment, thin film forming treatment of various polymers such as silane coupling agent, urethane polymer, and so forth.

The method of coating the black matrix resist composition on the transparent substrate includes dip coating, methods using a roll coater, a wire bar, a flow coater or a die coater and a spray coating, and in addition to these, a rotation coating method such as one using a spinner may be used advantageously.

The solvent is dried in a drying apparatus such as a hot plate, an IR oven, or a convection oven. Preferable drying conditions are 40 to 150° C. for a drying time in the range of 10 seconds to 60 minutes. Also, the solvent may be dried in a vacuum state.

The exposure method is as follows. After a gap of 50 to 200 μm is provided above the sample, a photo mask is placed thereon and image-wise exposure through the photomask is performed. Examples of the light source used for the exposure include lamp light sources such as a xenon lamp, a high pressure mercury lamp, a super high pressure mercury lamp, a metal halide lamp, a medium pressure mercury lamp, and a low pressure mercury lamp, laser light sources such as an argon ion laser, a YAG laser, an excimer laser, and a nitrogen laser. When only light with a specified wavelength of the irradiated light is used, an optical filter may be used.

The development treatment of the exposed resist is performed using a developing solution by a dip, shower, or paddle method or the like to wash and remove uncured parts. The developer is not particularly limited so far as it is a solvent that has ability to dissolve unexposed portion of a resist film. For example, acetone, methylene chloride, trichlene, cyclohexanone and the like organic solvents may be used. However, many of organic solvents cause environmental pollution, have toxicity to human body, and have a risk of causing fire, so that it is preferable to use alkali developers free from such risks. Examples of such alkali developer include aqueous solutions containing inorganic alkali agents such as sodium carbonate, potassium carbonate, sodium silicate, potassium silicate, sodium hydroxide, and potassium hydroxide, or organic alkali agents such as diethanolamine, triethanolamine and tetaralkylammonium hydroxide. The alkali developer may contain a surfactant, a water-soluble organic solvent, a low molecular compound having a hydroxyl group or a carboxyl group, as necessary In particular, surfactants, many of which have effects of improving developability, resolution, and stain, can be preferably added to the alkali developer.

Examples of surfactant for developing solution include anionic surfactants having a sodium naphthalenesulfonate group or a sodium benzenesulfonate group, nonionic surfactants having a polyalkyleneoxy group, and cationic surfactants having a tetraalkylammonium group.

The developing process is not particularly limited, however, developing is performed usually at a temperature of 10 to 50° C., preferably 15 to 45° C. by a dipping development method, a spray development method, a brush development method, a supersonic development method or the like.

The post baking is performed using the same apparatus as used for the solvent drying in a temperature range of 150 to 300° C. for 1 to 120 minutes.

The black matrix thus obtained may advantageously have a film thickness in the range of 0.1 to 1.5 μm, preferably 0.2 to 1.2 μm and further it is preferable that the optical density of the black matrix at such film thickness be 3 or more in order to function as a black matrix.

The black matrix pattern prepared in this step has an opening on the order of 20 to 200 μm between black matrices. In a later step, pixels are formed in this opening space.

Then, a plurality of color pixels are formed in the opening of the black matrix. Usually, the colors of the pixels are three colors, i.e., red (R), green (G), and blue (B). The photosensitive composition is colored with a pigment or dye. First, the photosensitive composition is coated onto the transparent substrate on which the black matrix pattern is mounted. Then, a solvent is dried in an oven or the like so that a colored layer of a first color is formed on the entire surface of the black matrix. Usually, a color filter includes pixels of a plurality of colors; unnecessary portions are removed by a photolithographic method to form a pixel pattern in the desired first color. The thickness of the pixel is on the order of 0.5 to 3 μm. This procedure is repeated by the number of times equal to the number of required colors to form pixels having a plurality of colors and thus a color filter is produced. Although it is preferable that the apparatus and chemicals used in the step for forming each pixel are the same as those used for forming the black matrix, there is no problem if they are different.

Thereafter, a protective layer is laminated as necessary. The protective layer may be made of acrylic resins, epoxy resins, silicone resins, polyimide resins or the like and is not particularly limited.

Further, other than the above method, there is a so-called backside exposure method, that is, a method in which after patterned pixels are preliminarily formed on a transparent substrate, the opposite side (backside) of the transparent substrate is coated with a black matrix resist composition, and then the transparent substrate is exposed to light from the front side to form a black matrix between the pixels using the pixels as masks.

Finally, lamination and patterning of an ITO (indium-tin oxide) transparent electrode is performed by a general method as necessary.

By use of the carbon black dispersion of the present invention and black matrix resist composition using the dispersion, a black matrix in the form of a thin film that has high light-shielding property and excellent thin line pattern due to high resolution can be formed.

### BEST MODE FOR CARRYING OUT THE INVENTION

Hereinafter, the present invention will be described by examples. However, the present invention is not limited by the examples.

### SYNTHESIS EXAMPLE 1

### Synthesis of Binder Resin (AP-1) Having a Carboxyl Group

In a four-necked flask equipped with a dropping funnel, a thermometer, a condenser tube and a stirrer, 37.5 mass parts of methacrylic acid (MA), 19.0 mass parts of methyl methacrylate (MMA), 18.5 mass parts of n-butyl methacrylate (BMA), 0.75 mass part of 2-mercaptoethanol, 225.0 mass parts of propylene glycol methyl-ether (PGM) were charged, and the inside of the four-necked flask was nitrogen-purged. Further, the temperature was elevated to 90° C. on an oil bath, and then a mixture of 37.5 mass parts of MA, 19.0 mass parts of MMA, 18.5 mass parts of BMA, 0.75 mass part of 2-mercaptoethanol, 225.0 mass parts of PGM, 3.2 mass parts of 2,2′-azobisisobutyronitrile (AIBN) was dripped over 1 hour. After polymerization was performed for 3 hours, the mixture was heated to 100° C. and a mixture of 1.0 mass part of AIBN and 15:0 mass parts of propylene glycol methyl ether acetate (PMA) was added, and then polymerization was performed for additional 1.5 hours, followed by standing to cool. Thereafter, the inside of the four-necked flask was air-purged, and 61.5 mass parts of glycidyl methacrylate (GMA), 3.6 mass parts of tetra-n-butylammonium bromide (TBAB), and 0.15 mass part of methoquinone were added. The reaction was performed at 80° C. for 8 hours to add GMA to the carboxyl group of the acrylic copolymer. The obtained GMA-added methacrylate copolymer was named AP-1. AP-1 had a solids content concentration of 30.5%, a solids content acid value of 116 mgKOH/g, and a weight average molecular weight of 14,000 in terms of polystyrene as measured by GPC.

### SYNTHESIS EXAMPLE 2

### Synthesis of Binder Resin (AP-2) Having a Carboxyl Group

In a four-necked flask equipped with a dropping funnel, a thermometer, a condenser tube and a stirrer, 17.5 mass parts of MA, 30.0 mass parts of MMA, 7.5 mass parts of benzyl methacrylate (BzMA), 20.0 mass parts of 2-hydroxyethyl methacrylate (HEMA) 0.75 mass part of 2-mercaptoethanol, 225.0 mass parts of PMA were charged and the inside of the four-necked flask was nitrogen-purged. Further, the temperature was elevated to 90° C. on an oil bath, and then a mixture of 17.5 mass parts of MA, 30.0 mass parts of MMA, 7.5 mass parts of BzMA, 20.0 mass parts of HEMA, 0.75 mass part of 2-mercaptoethanol, 225.0 mass parts of PMM, 3.2 mass parts of AIBN was dripped over 1 hour. After polymerization was performed for 3 hours, the mixture was heated to 100° C. and a mixture of 1.0 mass part of AIBN and 15.0 mass parts of PMA was added, and then polymerization was performed for additional 1.5 hours, followed by decreasing the temperature to 60° C. Thereafter, the inside of the four-necked flask was air-purged, and 48.0 mass parts of 2-methacryloyloxyethyl isocyanate (MEI) manufactured by Showa Denko K.K., 0.15 mass part of dibutyltin dilaurate, and 0.15 mass part of methoquinone were added and reaction was performed at 60° C. for 5 hours to add MEI to the hydroxyl group of the acrylic copolymer. The obtained MEI-added acrylic copolymer was named AP-2. AP-2 had a solid content concentration of 29.5%, a solid content acid value of 114 mgKOH/g, and a weight average molecular weight of 13,000 in terms of polystyrene as measured by GPC.

### SYNTHESIS EXAMPLE 3

### Synthesis of Copolymer (B) Having an Amino Group (DP-1)

In a four-necked flask equipped with a reflux condenser, a thermometer, a stirrer, and a dropping funnel, 40 mass parts of cyclohexanone was charged and the liquid temperature was maintained at 100° C. Under nitrogen atmosphere, a mixed solution consisting of 24 mass parts of ethyl acrylate, 4 mass parts of Macromonomer AA-6 (methyl methacrylate macromonomer) manufactured by Toa Gosei Co., Ltd., 12 mass parts of Light Ester DQ-100 (dimethylaminoethyl methacrylate, quaternarized product) manufactured by Kyoeisha Chemical Co., Ltd., 16 mass parts of Light Ester DM (dimethylaminoethyl methacrylate) manufactured by Kyoeisha Chemical Co., Ltd., 0.4 mass part of n-dodecylmercaptan, 0.8 mass part of AIBN, and 20 mass parts of cyclohexanone was dripped over about 3 hours. After completion of the dripping, further 0.5 mass part of AIBN was added and reaction was performed at 100° C. for 2 hours. The weight average molecular weight of the obtained copolymer measured by GPC was 20,000 in terms of polystyrene. The solids content concentration was 40.2%. This copolymer was named DP-1.

### SYNTHESIS EXAMPLE 4

### Synthesis of Copolymer (B) Having an Amino Group (DP-2)

The reaction was performed under the same conditions as those in Synthesis Example 3 except that the composition of the mixed solution to be dropped to cyclohexanone (40 mass parts) was changed so as to consist of phenoxyethyl methacrylate (Light Ester PO, manufactured by Kyoeisha Chemical Co., Ltd., 12 mass parts), Macro Monomer AA-6 (4 mass parts), Light Ester DQ-100 (8 mass parts), Light Ester DM (dimethylaminoethylmethacrylate, manufactured by Kyoeisha Chemical Co., Ltd., 16 mass parts), n-dodecylmercaptan (2 mass parts), and AIBN (0.8 mass part). The weight average molecular weight of the obtained copolymer measured by GPC was 20,000 in terms of polystyrene. The solid content concentration was 40.3%. This coplymer was named DP-2.

### SYNTHESIS EXAMPLE 5

### Synthesis of Copolymer (B) Having an Amino Group (DP-3)

The reaction was performed under the same conditions as those in Synthesis Example 3 except that the composition of the mixed solution to be dropped to cyclohexanone (40 mass parts) was changed so as to consist of NK ester M-20G (methoxydiethylene glycol methacrylate, 12 mass parts) manufactured by Shin-Nakamura Chemical Co., Ltd., Macro Monomer AA-6 (4 mass parts), Light Ester DQ-100 (8 mass parts), Light Ester DM (dimethylaminoethyl methacrylate, 16 mass parts), n-dodecylmercaptan (2 mass parts), and AIBN (0.8 mass part). The weight average molecular weight of the obtained copolymer measured by GPC was 20,000 in terms of polystyrene. The solid content concentration was 40.0%. This copolymer was named DP-3.

### SYNTHESIS EXAMPLE 6

### Synthesis of Photopolymerization Initiator Component

### “2,2′-bis(2-chlorophenyl)-4,4′,5,5′-tetrakis(4-methylphenyl)-1,2′-biimidazole (MHABI)”

In a 1-L volume egg-plant shaped flask, 27.50 g (115 mmol) of 4,4′-dimethylbenzil, 16.25 g (116 mmol) of o-chlorobenzaldehyde, 69.45 g (901 mmol) of ammonium acetate, and 450 g of acetic acid were introduced and reaction was performed at 117° C. for 5 hours while stirring. After standing to cool, the reaction mixture was slowly charged in 2 L of deionized water being stirred and 2-chlorophenyl-4,5-bis(4-methylphenyl)imidazole was precipitated. Thereafter, 2-chlorophenyl-4,5-bis (4-methylphenyl) imidazole was filtered and washed with water and then dissolved in 500 g of methylene chloride. The solution was charged in a 2 L volume four-necked flask and cooled to 5 to 10° C. To this was added a mixed solution consisting of 117.6 g (357 mmol) of potassium ferricyanide, 44.7 g of sodium hydroxide, and 600 g of deionized water over 1 hour while stirring. Further, reaction was performed at room temperature for 18 hours. The reaction mixture was washed with deionized water 3 times and then dehydrated over about 50 g of anhydrous magnesium sulfate, followed by evaporation of methylene chloride under reduced pressure. As a result, crystals of MHABI were formed. MHABI was recrystallized from ethanol, filtered, and dried. As a result, 36.5 g (yield 88.7%) of pale yellow crystals were obtained.

### SYNTHESIS EXAMPLE 7

### Synthesis of Photopolymerization Initiator Component

### “trimethylolpropane tris(3-mercaptoisobutyrate) (TPMB)”

In a 100 mL-volume egg-plant shaped flask, 2.68 g (20 mmol) of trimethylolpropane-manufacture-d by Tokyo Kasei Kogyo Co., Ltd., 7.57 g (63 mmol) of 3-mercaptobutanoic acid, 0.23 g 1.2 mmol) of p-toluenesulfonic acid monohydrate, and 20 g of toluene were charged and a Dean-Stark apparatus and a condenser tube were attached to the flask. The content was heated on an oil bath at an oil bath temperature of 145° C. while stirring. After 3 hours from the start of the reaction, the reaction mixture was left to cool, followed by neutralizing the reaction mixture with 50 ml of an aqueous 5% sodium hydrogen carbonate solution. Further, the reaction mixture was washed with deionized water 2 times and dehydrated and dried over anhydrous magnesium sulfate. Then, toluene was evaporated and the residue was subjected to silica gel column chromatography to purify TPMB. Wako GEL C-200 (manufactured by Wako Pure Chemical Industries Co., Ltd.) was used as silica gel and n-hexane/ethyl acetate=5:1 (volume ratio) was used as elution solvent. TPMB obtained after the purification was colorless transparent liquid. The yield was 5.63 g and percent yield was 64%.

Preparation of Carbon Black Dispersions

Using the carbon blacks having the properties shown in Table 1, carbon black dispersions were prepared by the method shown in Examples.

TABLE 1
Characteristics of Carbon Black

| | Surface | Primary | Specific | |
|---|---|---|---|---|
| | carboxyl | particle | surface | DBP oil |
| | concentration | diameter | area | absorption |
| Carbon Black | (μmol/m²) | (nm) | (m²/g) | (ml/100 g) |
| Special Black 250 | 0.60 | 56 | 40 | 46 |
| Raven 1040 | 0.65 | 28 | 92 | 100 |
| Raven 1060 | 0.58 | 30 | 66 | 50 |
| Raven 1080 | 0.61 | 28 | 84 | 60 |
| Special Black 4 | 1.94 | 25 | 180 | 88 |
| Printex 95 | <0.02 | 15 | 250 | 52 |

Special Black 250, Special Black 4, Printex 95: manufactured by Degussa
Raven 1040, Raven 1060, Raven 1080: manufactured by Columbian Carbon Co.

### EXAMPLE 1

After mixing 438 mass parts (solid content 210 mass parts) of Cyclomer ACA-200 (hereinafter, abbreviated as ACA-200, manufactured by Daicel Chemical Industries, Ltd., solid content concentration 48%, weight average molecular weight in terms of polystyrene 19,000, solid content acid value 116 mg/g) which is an acrylic ester copolymer having an acryloyl group and a carboxyl group in a side chain, DP-1 (210 mass parts (solid content 84 mass parts)), Special Black 250 as carbon black (manufactured by Degussa, 546 mass parts), and cyclohexanone (3,000 mass parts), the resultant was premixed using a disperser. Further, this mixed solution was dispersed in a continuous annular type bead mill (trade name: Spike Mill, Model SHG-4, manufactured by Inoue Seisakusho Co., Ltd.). The beads used were zirconia beads having a diameter of 0.65 mm and the filling ratio of the beads in the vessel was set to 80 volume %. The peripheral speed of the rotor was 12 m/second, the discharge rate of the carbon black dispersion was 1 liter/minute, and the temperature was set to about 30° C. The retention time of the carbon black dispersion in the vessel was set to 6 minute (for operation time of 1 hour). By the above-mentioned method, carbon black dispersion of Example 1 was obtained.

### EXAMPLES 2 TO 8 AND COMPARATIVE EXAMPLES 1 TO 3

In a manner similar to Example 1, carbon black dispersions of Examples 2 to 8 and Comparative Examples 1 to 3 having the compositions shown in Table 2 were obtained. Note that Disperbyk-161 in Comparative Example 3 is a urethane dispersant from Byk Chemie.

### COMPARATIVE EXAMPLE 4

In the same blend compositional ratios as those in Example 6, dispersion treatment was performed using a paint shaker as a disperser. Here, the blending amounts of ACA-200, DP-3, Raven 1080, and cyclohexanone were 6.3 mass parts (solids content 3.0 mass parts), 3.0 mass parts (solids content 1.2 mass parts), 7.8 mass parts, and 42.9 mass parts, respectively. The above-mentioned components were charged in a 160 ml volume stainless can. As the bead was used 380 g (filling ratio 80 volume %) of zirconia bead of 0.65 mm in diameter. The operation time was 1 hour.

Evaluation of Dispersability

Filtrability:

The dispersion degrees of carbon blacks in Examples 1 to 8 and Comparative Examples 1 to 4 were evaluated in terms of filtrability through a filter having a pore diameter of 0.8 μm (filter for GFP, manufactured by Kiriyama Glass Works Co.). When the dispersion was promptly filtered, the dispersibility was ∘ (acceptable), while when clogging occurred and filtration was unsuccessful, the dispersibility was x (unacceptable). The results obtained are shown in Table 2.

Glossiness

The dispersion of carbon blacks in Examples 1 to 8 and Comparative Examples 1 to 4 each were spin-coated on a glass plate of a size of 100×100×1 mm, and then dried at room temperature for 30 minutes and further at 70° C. for 20 minutes. Thereafter, glossiness was measured at an incident angle of 45° and a reflection angle of 45° using a digital variable glossimeter (Type UGV-50, manufactured by Suga Test Instruments Co., Ltd.). The greater the glossiness, the better the dispersibility of carbon black was judged to be. The results are shown in Table 2.

TABLE 2
Blending Composition ratio of Carbon Black Dispersion and Evaluation of Dispersibility

| | | Blending Composition of Carbon Black Dispersion (Mass Part) | | | | | |
|---|---|---|---|---|---|---|---|
| | | | Copolymer | | | | |
| | | Binder Resin | (B) Having | | | Evaluation of Dispersibility | |
| | | (D) Having a | an Amino | | Organic | | 45° |
| | | Carboxl Group | Group | Carbon Black (A) | Solvent (C) | Filtrability | Glossiness |
| Example | 1 | ACA-200 | DP-1 | Special Black 250 | Cyclohexanone | ◯ | 125 |
| | | 438 (210) | 210 (84) | 546 (546) | 3000 | | |
| | 2 | ACA-200 | DP-2 | Special Black 250 | Cyclohexanone | ◯ | 127 |
| | | 438 (210) | 210 (84) | 546 (546) | 3000 | | |
| | 3 | ACA-200 | DP-3 | Special Black 250 | Cyclohexanone | ◯ | 130 |
| | | 438 (210) | 210 (84) | 546 (546) | 3000 | | |
| | 4 | ACA-200 | DP-3 | Raven 1040 | Cyclohexanone | ◯ | 145 |
| | | 438 (210) | 210 (84) | 546 (546) | 3000 | | |
| | 5 | ACA-200 | DP-3 | Raven 1060 | Cyclohexanone | ◯ | 140 |
| | | 438 (210) | 210 (84) | 546 (546) | 3000 | | |
| | 6 | ACA-200 | DP-3 | Raven 1080 | Cyclohexanone | ◯ | 153 |
| | | 438 (210) | 210 (84) | 546 (546) | 3000 | | |
| | 7 | AP-1 | DP-3 | Raven 1080 | Cyclohexanone | ◯ | 155 |
| | | 689 (210) | 210 (84) | 546 (546) | 2750 | | |
| | 8 | AP-2 | DP-3 | Raven 1080 | Cyclohexanone | ◯ | 152 |
| | | 712 (210) | 210 (84) | 546 (546) | 2725 | | |
| Comparative | 1 | ACA-200 | DP-3 | Special Black 4 | Cyclohexanone | X | 110 |
| Example | | 438 (210) | 210 (84) | 546 (546) | 3000 | | |
| | 2 | ACA-200 | DP-3 | Printex 95 | Cyclohexanone | X | 85 |
| | | 438 (210) | 210 (84) | 546 (546) | 3000 | | |
| | 3 | ACA-200 | Disperbyk-161 | Raven 1080 | Cyclohexanone | X | 104 |
| | | 438 (210) | 280 (84) | 546 (546) | 2940 | | |
| | 4 | ACA-200 | DP-3 | Raven 1080 | Cyclohexanone | ◯ | 125 |
| | | 6.3 (3.0) | 3.0 (1.2) | 7.8 (7.8) | 42.9 | | |

*In the parentheses( ), solid composition is shown.

The results shown in Table Z indicate that by using specified carbon blacks and copolymer having an amino group and/or its quaternary ammonium salt, dispersion solutions with high dispersibility of carbon black were successfully prepared. In addition, comparison between Example 6 and Comparative Example 4 shows that use of the continuous annular type bead mill gave higher glossiness of the coating film and resulted in high dispersibility of carbon black.

Evaluation of Black Matrix Resist

The following reagents were used.

Compound (Monomer) (E) Having an Ethylenically Unsaturated Group

Dipentaerythritol hexaacrylate (hereinafter, abbreviated as “DPHA”: manufactured by Toa Gosei Co., Ltd.)
   Photopolymerization Initiator (F)
4,4′-Bis(N,N-diethylamino)benzophenone (hereinafter, abbreviated as “EMK”: manufactured by Hodogaya Chemicals Co., Ltd.)
   Organic Solvent (C)
Cyclohexanone (Wako Pure Chemical Industries, Ltd.).

### EXAMPLE 9

### Preparation of Black Matrix Resist

420 mass parts of carbon black dispersion of Example 1 (containing 21.0 mass parts of binder resin (D) having a carboxyl group, 8.4 mass parts of copolymer (B) having an amino group, and 54.6 mass parts of carbon black (A) as solids), 8.4 mass parts of DPHA as the monomer (E), 1.0 mass part of EMK and 5.0 mass parts of MHABI as the photopolymerization initiator (F), 5.0 mass parts of TPMB as the as the multifunctional thiol compound (G), and 150 mass parts of cyclohexanone were mixed and stirred for 2 hours, and then filtered through a filter having a pore diameter of 0.8 μm (filter for GFP manufactured by Kiriyama Glass Works Co.) to prepare a black matrix resist of Example 9. Examples 10 to 16 and Comparative Example 5:

Black matrix resist of Example 10 was prepared by using the carbon black dispersion of Example 2 in the same blending composition as that in Example 9. Hereinafter, similarly, the black matrix resist composition of Example 11 was prepared by using the carbon black dispersion of Example 3; the black matrix resist composition of Example 12 was prepared by using the carbon black dispersion of Example 4; the black matrix resist composition of Example 13 was prepared by using the carbon black dispersion of Example 5; the black matrix resist composition of Example 14 was prepared by using the carbon black dispersion of Example 6; the black matrix resist composition of Example 15 was prepared by using the carbon black dispersion of Example 7; the black matrix resist composition of Example 16 was prepared by using the carbon black dispersion of Example 8; and the black matrix resist composition of Comparative Example 5 was prepared by using the carbon black dispersion of Comparative Example 4.

Photosensitivity:

The black matrix resist compositions of Examples 9 to 16 and Comparative Example 5 each were spin-coated on glass substrates (size: 100×100×1 mm) to a dry thickness of about 1 μm and left to stand at room temperature for 30 minutes. Thereafter, the solvent was dried at 70° C. for 20 minutes. After the thickness of the dried resist was measured using a film thickness gauge (manufactured by Tokyo Seimitsu Co., Ltd., SURFCOM 130A), the resist was photocured through a quartz made photomask in an exposing apparatus having incorporated therein a super high pressure mercury lamp (manufactured by Ushio Inc., trade name Multilight ML-251A/B) with stepwise varying the exposure amount. The exposure amount was measured using an ultraviolet integral actinometer (manufactured by Ushio Inc., trade name UIT-150, light receiving part UVD-S365). The quarts made photomask used had formed therein with line/space patterns of 5, 7, 10, 30, 50, 70, or 100 μm.

The exposed resist was alkali-developed with an aqueous solution (25° C.) containing 0.25% of Developer 9033 (manufactured by Shipley Far East Ltd.), which is an alkali developer containing potassium carbonate, and 0.03% of sodium dodecylbenzenesulfonate for a predetermined time (the developing time was set to double the time (tD) required for the film before exposure to be completely dissolved by alkali development; in the present example, tD was 15 seconds and thus the development time was set to 30 seconds). After the alkali development, the glass substrates were washed and then dried by air spray. The thickness of the resist films that remained was measured and remaining film ratios were calculated. The remaining film ratios were calculated according to the following formula. Similar photocuring operations were performed by varying the exposure amount, and the relationship between the exposure amount and remaining film ratio was plotted in a graph. From the graph, the exposure amount at which the remaining film ratio reached saturation was obtained.
Remaining film ratio(%)={(film thickness after alkali development)/(film thickness before alkali development)}×100

Next, the line width of the resist formed at a portion where the line/space of the photomask was 10 μm was measured under an optical microscope (manufactured by Keyence Corporation, VH-Z250)

The minimum exposure amount at which the remaining film ratio after alkali development reached saturation and the same line width as that of the photomask was obtained by the above-mentioned method was defined as the photosensitivity of the black matrix resist. The results obtained are shown in Table 3.

Linearity of Thin Line:

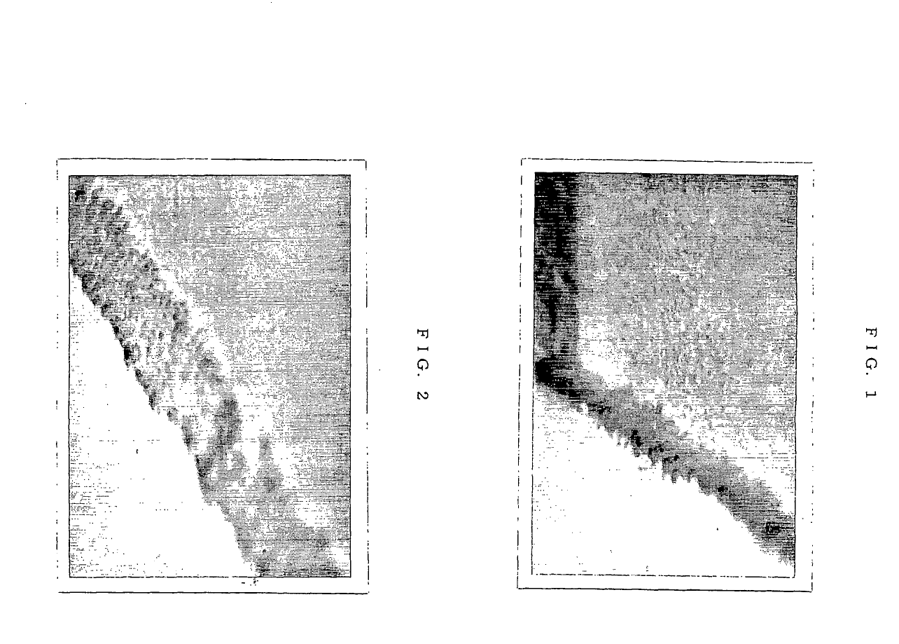

The 10 μm line width portions of the resists fabricated in Examples 9 to 16 and Comparative example 5 for the evaluation of the photosensitivity were observed on a scanning electron microscope (manufactured by JEOL, JSM-T330A), and the case in which the thin line showed good linearity was judged to be acceptable (◯) while the case in which the thin line showed poor linearity was judged to be unacceptable (x). FIG. 1 is an electron micrograph showing good linearity of thin line (Example 16) and FIG. 2 is an electron micrograph showing poor linearity of thin line (Comparative Example 5). In the case of FIG. 2, the edges of the thin line appear uneven. The results are shown in Table 3.

Resolution:

In the evaluation of photosensitivity described above, each black matrix resist was photocured with an exposure amount that corresponded to its photosensitivity, alkali developed in the same manner as described above and observed under an optical microscope. The minimum line width that remained and was equivalent to that of the photomask was defined as resolution of the black matrix resist. The results obtained are shown in Table 3.

OD (Optical Density) Value:

The black matrix resist compositions of Examples 9 to 16 and Comparative Example 5 were spin-coated on a glass substrates (size: 100×100×1 mm) dried at room temperature for 30 minutes, followed by drying the solvent at 70° C. for 20 minutes. After photocuring at exposure amounts corresponding to the respective resists using an ultra-high pressure mercury lamp, the resists were post-baked at 200° C. for 30 minutes, and the obtained glass substrates coated with resists were used to measure OD values. The OD values were determined using a calibration curve prepared by measuring a transmittance at 550 nm using a standard plate whose OD value was already known. The results obtained are shown in Table 3.

TABLE 3
Evaluation of Black Resists

| | Photo- | Linearity | | |
|---|---|---|---|---|
| | sensitivity | of Thin | Resolution | OD Value |
| | (mJ/cm²) | Line | (μm) | (/μm) |
| Example 9 | 50 | ◯ | 7 | 4.2 |
| Example 10 | 50 | ◯ | 7 | 4.2 |
| Example 11 | 50 | ◯ | 7 | 4.2 |
| Example 12 | 100 | ◯ | 5 | 4.0 |
| Example 13 | 100 | ◯ | 5 | 4.1 |
| Example 14 | 80 | ◯ | 5 | 4.0 |
| Example 15 | 80 | ◯ | 5 | 4.0 |
| Example 16 | 80 | ◯ | 5 | 4.0 |
| Comparative | 80 | X | 10 | 3.7 |
| Example 5 | | | | |

### INDUSTRIAL APPLICABILITY

By using a specific carbon black and a copolymer having an amino group and/or its quaternary ammonium salt, a dispersion having excellent dispersibility of carbon black can be prepared. Especially, use of a continuous annular type bead mill contributes to higher dispersibility of carbon black in such a dispersion. As a result, as shown in Table 3, black matrix resist having a high OD value and yet having excellent resolution and linearity of thin line can be obtained.

1. A carbon black dispersion composition for a color filter black matrix resist containing (A) a carbon black having an average primary particle diameter of 20 to 60 nm, a DBP oil absorption of 30 to 100 ml/100 g, a specific surface area by a BET method of 30 to 150 m²/g, and a concentration of carboxyl group on a particle surface of 0.2 to 1.0 μmol/m², (B) a copolymer having an amino group and/or its quaternary ammonium salt, and (C) an organic solvent.

2. The carbon black dispersion composition for a color filter black matrix resist according to claim 1, wherein the copolymer (B) having an amino group and/or its quaternary ammonium salt is obtained by copolymerizing monomers (i), (ii) and (iii) below:
(i) 10 to 85 mass parts of at least one (meth)acrylate monomer selected from (a) a (meth)acrylic acid alkyl ester containing an alkyl group having 1 to 18 carbon atoms, (b) a (meth)acrylic acid ester represented by formula (1) below 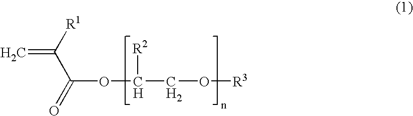
(in the formula, R¹ and R², which may be the same or different, each represents a hydrogen atom or a methyl group, R³ represents an alkyl group having 1 to 18 carbon atoms, n is an integer of 1 to 50), (c) a (meth)acrylic acid ester represented by formula (2) below 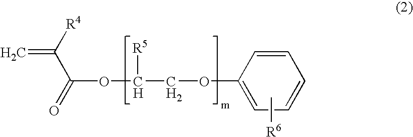
(in the formula, R⁴ and R⁵, which may be the same or different, each represents a hydrogen atom or a methyl group, R⁶ represents an alkyl group having 1 to 18 carbon atoms, m is an integer of 1 to 50), and (d) a (meth)acrylic acid ester having a hydroxyl group,
(ii) 10 to 85 mass parts of an aminoalkyl (meth)acrylate monomer represented by formula (3) below 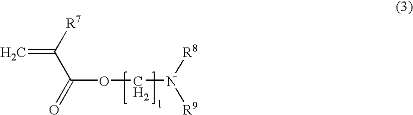
(in the formula, R⁷ represents a hydrogen atom or a methyl group, R⁸ and R⁹, which may be the same or different, each represents an alkyl group having 1 to 6 carbon atoms, 1 is an integer of 2 to 8), and/or a quaternary ammonium (meth)acrylate monomer represented by formula (4) below 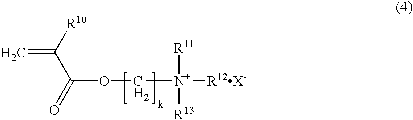
(in the formula, R¹⁰ represents a hydrogen atom or a methyl group, R¹¹, R¹² and R¹³, which may be the same or different, each represents an alkyl group having 1 to 6 carbon atoms, a hydroxyalkyl group having 2 to 6 carbon atoms, an alkoxyalkyl group having 1 to 4 carbon atoms, a cycloalkyl group, an aralkyl group, a phenyl group, or a halogenated aryl group, X⁻ represents a halogen ion or an anion residue of an acid, and k is an integer of 2 to 8),
(iii) 5 to 80 mass parts of at least one selected from a polyalkyl (meth)acrylate macromonomer and a polystyrene macromonomer, having a (meth)acryloyl group at the terminal (provided that the total of (i) to (iii) is 100 mass parts).

3. The carbon black dispersion composition for a color filter black matrix resist according to claim 1 or 2, wherein the ratio of the carbon black (A) and the copolymer (B) having an amino group or its quaternary ammonium salt is (A):(B)=100:5 to 100:25 by mass ratio.

4. The carbon black dispersion composition for a color filter black matrix resist according to claim 1, wherein further comprising (D) a binder resin having a carboxyl group.

5. The carbon black dispersion composition for a color filter black matrix resist according to claim 1, wherein the dispersion is produced by using a continuous annular type bead mill.

6. A color filter black matrix resist composition comprising components (A), (B), (C), (D), (E), (F), and (G) below:
(A) a carbon black having an average primary particle diameter of 20 to 60 nm, a DBP oil absorption of 30 to 100 ml/100 g, a specific surface area by a BET method of 30 to 150 m²/g, and a concentration of carboxyl group on a particle surface of 0.2 to 1.0 μmol/m²,
(B) a copolymer having an amino group and/or its quaternary ammonium salt,
(C) an organic solvent,
(D) a binder resin having a carboxyl group,
(E), an ethylenically unsaturated monomer,
(F) a photopolymerization initiator, and
(G) a multifunctional thiol compound having two or more mercapto groups.

7. The color filter black matrix resist composition according to claim 6, wherein the components other than the organic solvent (C) are contained in the following ratios:
(A) 40 to 80 mass %, (B) 4 to 50 mass %, (D) 10 to 50 mass %, (E) 3 to 45 mass %, (F) 2 to 45 mass %, and (G) 2 to 45 mass %.

8. The color filter black matrix resist composition according to claim 6, wherein the copolymer (B) having an amino group and/or its quaternary ammonium salt is a (meth)acrylic copolymer having a number average molecular weight of 4,000 to 100,000 obtained by copolymerizing monomers (i), (ii), and (iii) below:
(i) 10 to 85 mass parts of at least one (meth)acrylate monomer selected from (a) a (meth)acrylic acid alkyl ester containing an alkyl group having 1 to 18 carbon atoms, (b), a (meth)acrylic acid ester represented by formula (1) below 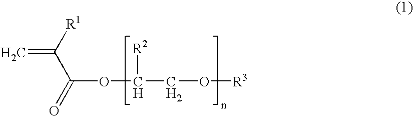
(in the formula, the symbols in the formula have the same meanings as defined in claim 2), (c) a (meth)acrylic acid ester represented by formula (2) below 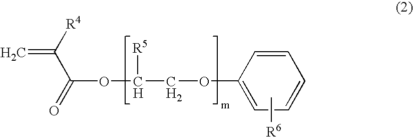
(in the formula, the symbols have the same meanings as those in claim 2), and (d) a (meth)acrylic acid ester having a hydroxyl group,
(ii) 10 to 85 mass parts of an aminoalkyl (meth)acrylate monomer represented by formula (3) below 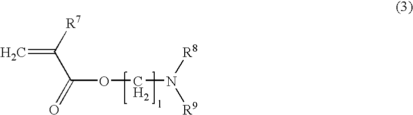
(in the formula, the symbols have the same meanings as those in claim 2), and/or a quaternary ammonium (meth)acrylate monomer represented by formula (4) below 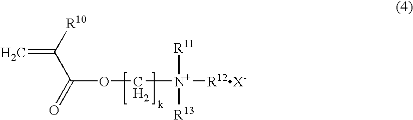
(in the formula, the symbols have the same meanings as those in claim 2),
(iii) 5 to 80 mass parts of at least one selected from a polyalkyl (meth)acrylate macromonomer and a polystyrene macromonomer, having a (meth)acryloyl group at the terminal (provided that the total of (i) to (iii) is 100 mass parts).

9. The color filter black matrix resist composition according to claim 8, wherein the binder (D) having a carboxyl group has further an ethylenically unsaturated group.
